(19) United States
(12) Patent Application Publication
(10) Pub. No.: US 2013/0121162 A1
(43) Pub. Date: May 16, 2013

(54) COMMUNICATION SYSTEM FOR POWER DISTRIBUTION, COMMUNICATION ROUTE SETTING APPARATUS AND METHOD

(71) Applicant: HITACHI, LTD., Tokyo (JP)

(72) Inventor: Kazutoshi TSUCHIYA, Tokyo (JP)

(73) Assignee: HITACHI, LTD., Tokyo (JP)

(21) Appl. No.: 13/676,674

(22) Filed: Nov. 14, 2012

(30) Foreign Application Priority Data
Nov. 15, 2011 (JP) 2011-249777

(51) Int. Cl. H04W 24/06

(52) U.S. Cl. CPC H04W 24/06
USPC 370/241

(57) ABSTRACT

Measurement apparatuses have the function of communicating with other measurement apparatuses within a predetermined range by radio. A simulated communication management part of a relay apparatus manages simulated communication of the measurement apparatuses and collects communication results to be managed. A statistical processing part of a communication route setting apparatus statistically processes the results of the simulated communication. An estimation part sets communication routes among the measurement apparatuses on the basis of results of the statistical processing and information from a route information database. The communication routes prepared by a communication route preparation part are notified from a communication route notification part through the relay apparatus to the measurement apparatuses.

### BACKGROUND OF THE INVENTION

The present invention relates to a communication system for power distribution, a communication route setting apparatus and a method.

In recent years, distributed power generation apparatuses such as photovoltaic power generation apparatuses and wind power generation apparatuses are demanded to be connected to a power system from the viewpoint of prevention of the global warming. However, output of the distributed power generation apparatuses is generally affected by the weather and unstable.

Accordingly, it is demanded that measurement apparatuses having the communication function are installed in various places of the power system to control the distributed power generation apparatuses and accumulation apparatuses. As the measurement apparatuses having the communication function, advanced meter infrastructures (AMI) and switches with sensor are considered, for example. In order to collect data from the measurement apparatuses, radio communication or power line communication (PLC) can be used.

As a prior art, there is known a system of optimizing the number of relays by communication apparatuses (JP-A-2010-199742). In this prior art, when a TC (Topology Control) message is transmitted from a communication end station to a gateway, TTL (Time To Live) is set in consideration of the number of hops (the number of relays) from the communication end station to the gateway. The TTL is an effective time of packet.

For example, when 7 hops are required as the number of hops on a route leading from the communication end station to the gateway, TTL is 7 (TTL=7). Each time the TC message transmitted from the communication end station passes through one hop, TTL is reduced one by one and the TC message reaches the gateway. When the TC message reaches the gateway, TTL is 0 (TTL=0) and the TC message is destroyed. Accordingly, the TC message is not transmitted to a communication end station installed behind the gateway.

### SUMMARY OF THE INVENTION

In the prior art, information can be transmitted through the hops in the optimum number without passing through useless communication end stations. However, when any communication trouble occurs in a communication end station on the way of transmission route of the information, it is apprehended that the information is lacking.

For example, when the communication trouble occurs in a certain communication end station in case where packet is transmitted between adjacent communication end stations in a so-called bucket-brigade method, information in other communication end stations on the communication route taken up to that time cannot be transmitted upstream of the communication end station where the trouble occurs and is lost. In the prior art, there is no means for confirming the reliability of the communication route and accordingly if it is supposed that the communication end station where trouble is liable to occur is installed near the gateway, there is a possibility that a lot of information is frequently lacking.

Accordingly, it is an object of the present invention to provide a communication system for power distribution, a communication route setting apparatus and a method in which communication routes for communicating with plural measurement apparatuses can be set with relatively high reliability.

In order to solve the above problem, in the communication system for power distribution according to one viewpoint of the present invention for communicating with plural measurement apparatuses included in a power distribution network, the measurement apparatuses have the function to communicate with other measurement apparatuses within a predetermined range by radio and the communication system comprises a simulated communication result collection part to collect results of simulated communication performed among the measurement apparatuses and the other measurement apparatuses residing within the predetermined range and manage the results and a communication route setting part to set communication routes among the measurement apparatuses on basis of the results of the simulated communication obtained from the simulated communication result collection part. The communication route setting part decides a measurement apparatus of a communication party of each measurement apparatus for each of the measurement apparatuses on the basis of the results of the simulated communication at least one by one and notifies information about the measurement apparatus decided as the communication party to the measurement apparatuses to set the communication routes.

The simulated communication is performed plural times among the measurement apparatuses and the communication route setting part statistically processes success or failure of the simulated communication and estimates results of the statistical processing, so that the communication route setting part decides the measurement apparatus of the communication party from among the measurement apparatuses with which the measurement apparatuses can communicate for each of the measurement apparatuses on the basis of the estimation of the statistical processing at least one by one.

The communication route setting part obtains records of communication trouble from a communication trouble information management part which manages information about communication trouble and can decides the measurement apparatus of the communication party from among the measurement apparatuses with which the measurement apparatuses can communicate for each of the measurement apparatuses on the basis of the result of the statistical processing and the records of the communication trouble at least one by one.

The communication route setting part statistically processes success or failure of the simulated communication so that points is made smaller as the number of successes of the simulated communication is increased and can decide a measurement apparatus having smallest points and the minimum number of times of occurrences of the communication trouble from among the measurement apparatuses with which the measurement apparatuses can communicate as the measurement apparatus of the communication party at least one by one for each of the measurement apparatuses.

The communication route setting part can also set the communication route so that measurement apparatuses in combination with each other are installed nearer the simulated communication result collection part in case where the measurement apparatuses in the combination have the smallest points and the minimum number of times of occurrences of the communication trouble.

The communication route setting part detects the communication route containing the combination of first measurement apparatuses having the smallest points and the minimum number of times of occurrences of the communication trouble as a main communication route and may set the communication route so that second measurement apparatuses which do not belong to the main communication route among the measurement apparatuses and can communicate with any of first measurement apparatuses are connected to any of the first measurement apparatuses communicable therewith. Further, the communication route setting part may set the communication route so that third measurement apparatuses which do not belong to the main communication route among the measurement apparatuses and cannot directly communicate with any of the first measurement apparatuses are connected to any of the second measurement apparatuses communicable therewith among the second measurement apparatuses.

At least part of the configuration of the present invention can be realized by a computer program. The computer program can be distributed by means of a communication medium such as the Internet and a recording medium such as a hard disk and a flash memory device, for example. Furthermore, part of the configuration of the present invention can be configured by an electronic circuit.

Other objects, features and advantages of the invention will become apparent from the following description of the embodiments of the invention taken in conjunction with the accompanying drawings.

### BRIEF DESCRIPTION OF THE DRAWINGS

FIG. 1 schematically illustrates the whole of a communication system for power distribution according to an embodiment of the present invention;

FIG. 2 is a diagram illustrating an example of simulated communication among measurement apparatuses;

FIG. 3 shows an example of a table in which results of the simulated communication are brought together;

FIG. 4 shows an example of a table representing communication routes among measurement apparatuses;

FIG. 5 shows another example of a table representing communication routes;

FIG. 6 schematically illustrates configuration examples of communication routes among measurement apparatuses;

FIG. 7 is a flow chart showing processing of performing simulated communication among measurement apparatuses;

FIG. 8 is a flow chart showing an example of processing of setting a communication route;

FIG. 9 is a flow chart showing another example of processing of setting a communication route;

FIG. 10 is a flow chart showing processing of changing a communication route according to a second embodiment of the present invention;

FIG. 11 schematically illustrates a configuration example of a communication route among measurement apparatuses according to a third embodiment of the present invention; and

FIG. 12 is a flow chart showing an example of processing of changing a communication route.

### DESCRIPTION OF THE EMBODIMENTS

Embodiments of the present invention are now described with reference to the accompanying drawings. In the embodiments, as described below in detail, the communication state among plural measurement apparatuses (530, 630 and 650) included in power distribution systems (power distribution networks) 50 and 60 is estimated beforehand to set a communication route with high stability.

Consequently, in the embodiments, the possibility that measurement data is lost or lacking due to communication trouble or the like can be reduced and the reliability of a communication system for power distribution can be improved.

### Embodiment 1

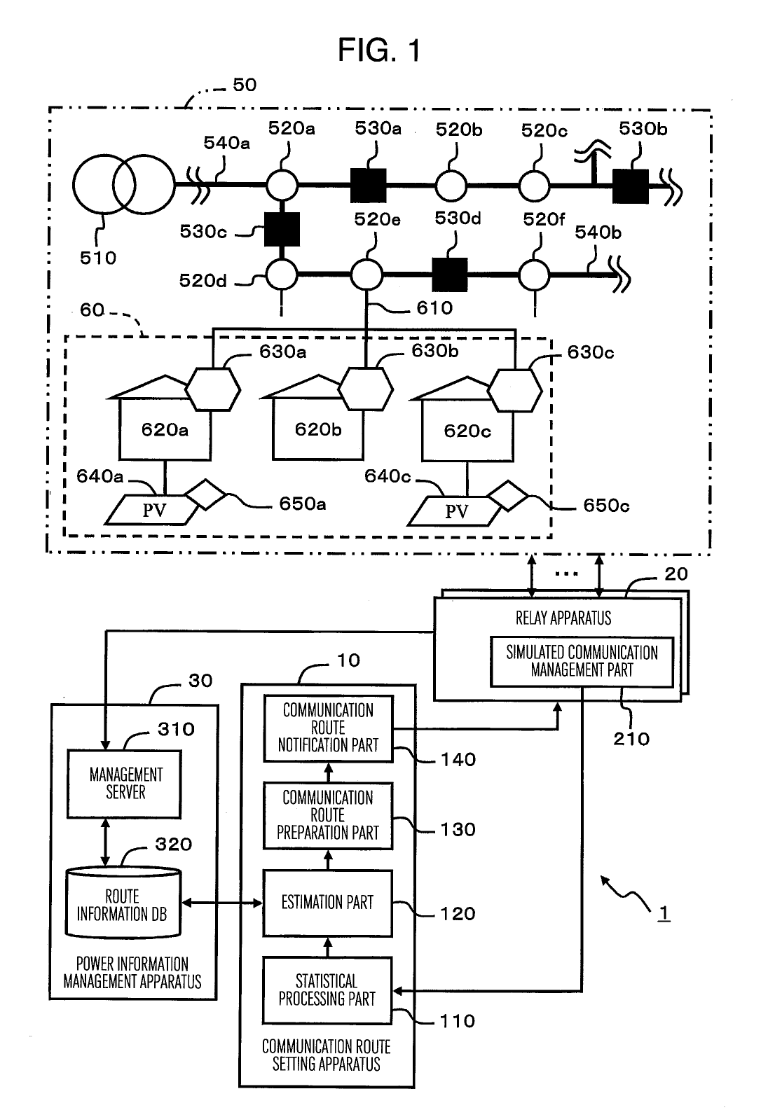

FIG. 1 schematically illustrates the whole of a communication system 1 for power distribution. The communication system 1 comprises a relay apparatus 20 which totalizes results of simulated communication among various measurement apparatuses 530, 630 and 650 installed in a high-voltage power distribution system 50 and a low-voltage power distribution system 60. A communication route setting apparatus 10 sets a communication route among the measurement apparatuses on the basis of the results of simulated communication obtained from the relay apparatus 20 and route information obtained from a power information management apparatus 30.

The configuration of the power distribution network is first described. The power distribution network includes the high-voltage power distribution system 50 and the low-voltage power distribution system 60. In the embodiment, the scale of one feeder extending from a transformer 510 of a power distribution transformer substation is supposed as the high-voltage power distribution system 50. The high-voltage power distribution system 50 includes the transformer 510, plural pole-mounted transformers 520a to 520f shown as nodes, plural switches 530a to 530f with measurement apparatuses and high-voltage distribution lines 540a and 540b, for example. Unless otherwise specified, alphabets affixed to reference numerals are omitted. For example, the pole-mounted transformers 520a to 520f are sometimes described as the pole-mounted transformers 520.

The low-voltage power distribution system 60 supplies electric power from the high-voltage distribution lines to plural consumers 620a to 620c connected to a low-voltage distribution line 610. In an example of FIG. 1, the low-voltage power distribution system 60 is connected to a certain pole-mounted transformer 520e. Other pole-mounted transformers 520a to 520d and 520f are also connected to the low-voltage power distribution system 60 similarly so that electric power is supplied to plural consumers.

The consumers 620a to 620c contained in the low-voltage power distribution system 60 are, for example, general private homes, factories, commercial stores, hospitals, buildings, apartment houses and the like. The consumers 620a to 620c are provided with measurement apparatuses 630a to 630c. For example, the measurement apparatuses 630a to 630c measure power consumption of consumers periodically and transmit the measured data to a power information management apparatus 30 through the relay apparatus 20. The measurement apparatuses 630a to 630c are constructed as automatic power meters, power measuring meter and the like, for example.

The consumers 620a and 620c which are part of the plural consumers 620a to 620c can be provided with distributed power generation apparatuses 640a and 640c, respectively. As the distributed power generation apparatuses, for example, photovoltaic power generation apparatuses, wind power generation apparatuses, accumulation apparatuses, electric vehicles and the like can be mentioned. The distributed power generation apparatuses 640a and 640c are provided with measurement apparatuses 650a and 650c, respectively. The measurement apparatuses 650a and 650c measure power generation amounts or accumulation amounts of the distributed power generation apparatuses 640a and 640c and transmit the measured data to the power information management apparatus 30, for example.

Configuration about information communication is described. Description is made in order of the relay apparatus 20, the power information management apparatus 30 and the communication route setting apparatus 10.

The relay apparatus 20 which is an example of a “simulated communication result collection part” receives measured data from the measurement apparatuses 520, 530, 630 and 650 and transmits the measured data to the power information management apparatus 30.

The measured data is transmitted to the relay apparatus 20 in each kind of the measurement apparatuses. That is, the measured data of the switches 530 with measurement apparatuses is transmitted to the relay apparatus 20 in the bucket-brigade method of the switches 530. The measured data of the measurement apparatuses 630 of the consumers 620 is also transmitted to the relay apparatus 20 in the bucket-brigade method of the measurement apparatuses 630. The measured data of the measurement apparatuses 650 of the distributed power generation apparatuses 640 is also transmitted to the relay apparatus 20 in the bucket-brigade method of the measurement apparatuses 650.

The relay apparatus 20 transfers the measured data from the measurement apparatuses 520, 530, 630 and 650 to the power information management apparatus 30. The relay apparatus 20 can also notify instructions from the power information management apparatus 30 to the measurement apparatuses 520, 530, 630 and 650.

Furthermore, the relay apparatus 20 of the embodiment manages simulated communication among the measurement apparatuses to be totalized as described later. A simulated communication management part 210 included in the relay apparatus 20 obtains results of simulated communication among the measurement apparatuses to totalize the results and transmits the totalized result to the communication route setting apparatus 10. Further, the relay apparatus 20 notifies instructions from the communication route setting apparatus 10 to the measurement apparatuses.

The simulated communication management part 210 obtains results of simulated communication performed by the measurement apparatuses 520, 530, 630 and 650 periodically or irregularly. The time intervals at which simulated communication is performed can be adjusted to the measurement intervals of the measurement apparatuses. The simulated communication timing may be designated once a day, once a week or the like, for example, instead of coinciding it with the measurement timing.

The relay apparatus 20 can be installed in every feeder line or in every transformer bank of the power distribution transformer substation. Alternatively, the relay apparatus 20 may be installed in every pole-mounted transformer 520. The power information management apparatus 30 and the communication route setting apparatus 10 can be installed in every power distribution transformer substation or every transformer bank or every feeder line.

The power information management apparatus 30 is a computer system for collecting power information from the power distribution systems 50 and 60 and managing it. The power information management apparatus 30 includes, for example, a management server 310 and a route information database 320. As the power information, for example, information concerning voltage, current, power and frequency can be enumerated. The route information database 320 is provided in a storage device such as, for example, a hard disk drive, a flash memory device and a random access memory (RAM).

The management server 310 receives power information from the measurement apparatuses 520, 530, 630 and 650 through the relay apparatus 20 and performs predetermined information processing. The management server 310 can provide, for example, electric power business companies, electric power consultant companies, electric appliance manufacturing companies and the like with results of the information processing.

The route information database 320 is an example of a “communication trouble information management part”. The route information database 320 can store therein information concerning configuration of the measurement apparatuses 520, 530, 630 and 650 and information concerning communication records of the measurement apparatuses 520, 530, 630 and 650, for example.

The information concerning the configuration of the measurement apparatuses contains, for example, management numbers, names of kind of apparatuses, maker names, installation places, installation areas and the like. The information concerning the communication records contains, for example, trouble records, the number of times of occurrences of communication trouble, configuration of past communication routes (route list) and the like.

The communication route setting apparatus 10 is a computer system for setting communication routes among the measurement apparatuses of the same kind. The communication route setting apparatus 10 includes, for example, a statistical processing part 110, an estimation part 120, a communication route preparation part 130 and a communication route notification part 140.

The statistical processing part 110 gives points to the stability of communication routes among the measurement apparatuses on the basis of information obtained from the simulated communication management part 210 of the relay apparatus 20 as described later. The stability is the number of times of successes of simulated communication representing that simulated communication among the measurement apparatuses are successful, for example. The estimation part 120 selects one or plural measurement apparatuses for each of measurement apparatuses as candidates of communication party on the basis of the points calculated by statistical processing.

More particularly, the estimation part 120 decides a measurement apparatus of the communication party from among measurement apparatuses with which the measurement apparatuses can communicate for each of measurement apparatuses on the basis of the points calculated by statistical processing and records of communication trouble obtained from the route information database 320 at least one by one.

The communication route preparation part 130 prepares a communication route of measurement apparatuses in accordance with a combination of a measurement apparatus for communication source and a measurement apparatus for a communication destination decided by the estimation part 120. The communication route notification part 140 notifies the prepared communication route to the measurement apparatuses 520, 530, 630 and 650 through the relay apparatus 20.

The communication route setting apparatus 10 can set the communication route among the measurement apparatuses in accordance with totalization of simulated communication by the simulated communication management part 210. Alternatively, the communication route setting apparatus 10 can set the communication route among the measurement apparatuses when configuration in a sensor network (network consisting of measurement apparatuses 520, 530, 630 and 650) within the power distribution systems 50 and 60 is changed, for example. Further, the communication route setting apparatus 10 may set the communication route periodically or irregularly at different timing from totalization timing of the simulated communication results.

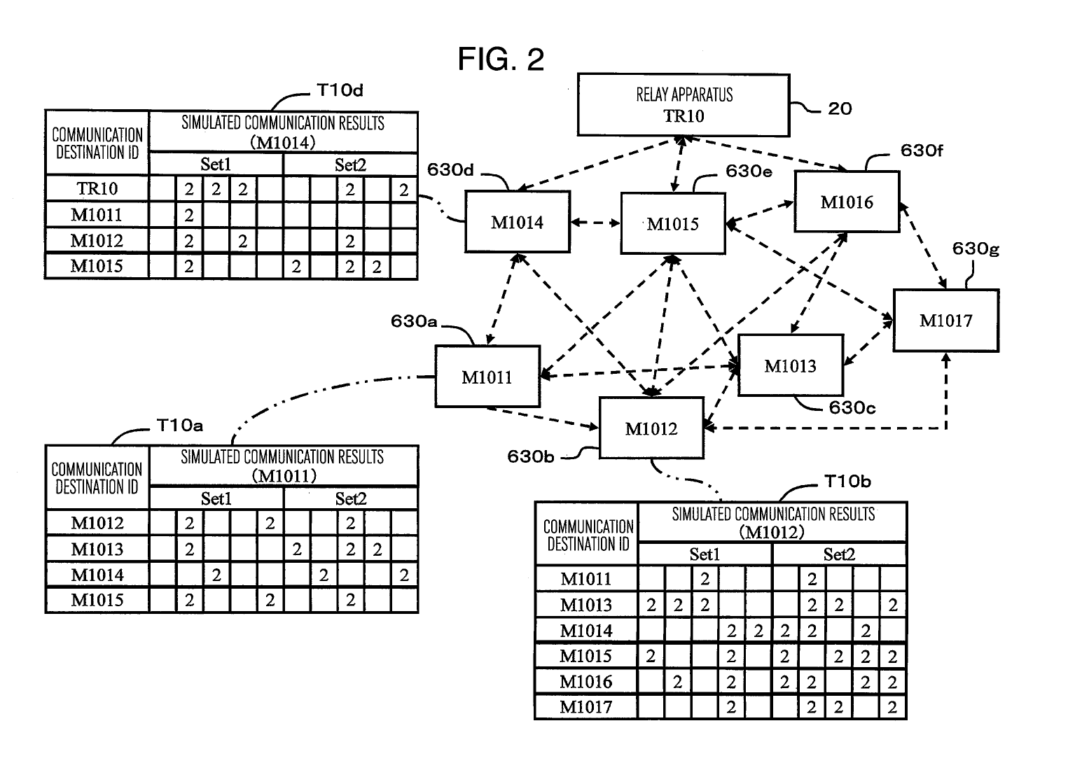

Referring now to FIG. 2, the state of simulated communication among the measurement apparatuses is described. For convenience of description, the following description is made centering on the measurement apparatuses 630 of consumers, although the embodiment can be applied even to other measurement apparatuses 530 and 650 except the measurement apparatuses 630 of consumers.

FIG. 2 illustrates an example of simulated communication among measurement apparatuses 630a to 630g belonging to a predetermined area. In FIG. 2, seven measurement apparatuses 630a to 630g and one relay apparatus 20 are shown. ID of the relay apparatus 20 is “TRIO”. ID's of the measurement apparatuses 630a to 630g are M1011, M1012, M1013, M1014, M1015, M1016 and M1017.

The predetermined area is an area in which the consumers 620 connected electrically to the same pole-mounted transformer 520 reside. In the embodiment, area is sectioned for each of pole-mounted transformers 520. The area can be set freely and may be sectioned by city, town or village, by predetermined distance or by predetermined area, for example.

As shown in FIG. 2, the measurement apparatuses 630a to 630g have the radio communication function and perform simulated communication with other measurement apparatuses within the communication range by radio. The state of simulated communication by radio is shown by broken lines connecting the measurement apparatuses in FIG. 2.

While the measurement apparatuses 630a to 630g measure electric energy, the relay apparatus 20 and the measurement apparatuses 630a to 630g transmit packet information to other apparatuses residing around to make simulated communication. The timing of simulated communication is decided beforehand and internal timers of the apparatuses 20, 630a to 630g are assumed to be synchronized. In the embodiment, sudden change in environment is considered and simulated communication is made two sets in total where one set is defined to be five times, for example. Since it is sufficient if simulated communication is made plural times among the measurement apparatuses residing around, it is not necessary to make simulated communication two sets where one set is five times. In the following description, information exchanged among the apparatuses is sometimes named packet simply.

In FIG. 2, results of simulated communication in case where the measurement apparatuses 630a (M1011), 630b (M1012) and 630d (M1014) are supposed to be communication sources and are shown in tables T10a, T10b and T10d. Before communication routes for transferring measurement information among the measurement apparatuses 630a to 630g are prepared, the measurement apparatuses 630a to 630g perform simulated communication among other measurement apparatuses within predetermined range. The measurement apparatuses 630a to 630g memorize reception records of the simulated communication in table T10 (other tables except tables T10a, T10b and T10d are not shown).

In case of the measurement apparatus 630a, simulated communication parties residing within the predetermined range are four measurement apparatuses 630b, 630c, 630d and 630e in total. The predetermined range is an area in which the measurement apparatus 630a can make radio communication.

Results of the simulated communication performed between the measurement apparatuses 630a (M1011) and 630b (M1012) are stored in the first line of the table T10a. Results of the simulated communication performed between the measurement apparatuses 630a (M1011) and 630c (M1013) are stored in the second line of the table T10a. Similarly, results of the simulated communication performed between the measurement apparatuses 630a (M1011) and 630d (M1014) and the measurement apparatuses 630a (M1011) and 630e (M1015) are stored in the third and fourth lines of the table T10a, respectively. The meaning of numerical values in the table is described later.

Similarly, the table T10d shows reception records of simulated communication in which the measurement apparatus 630d (M1014) is a communication source. The table T10b shows reception records of simulated communication in which the measurement apparatus 630b (M1012) is a communication source. When the measurement apparatuses 630a to 630g do not receive a signal due to be transmitted from simulated communication parties, the effect that the signal is not received is memorized.

The meaning of the numerical values in the table is now described. When the measurement apparatuses 630a to 630g are not distinguished, they are sometimes named the measurement apparatus 630 hereinafter.

The statistical processing part 110 of the communication route setting apparatus 10 estimates communication success frequencies in the measurement apparatuses 630 by points on the basis of the simulated communication results obtained by the relay apparatus 20. The simulated communication is made between one measurement apparatus and the other measurement apparatus bidirectionally. Both of the simulated communication in which one measurement apparatus is a communication source and the other measurement apparatus is a communication destination and the simulated communication in which one measurement apparatus is a communication destination and the other measurement apparatus is a communication source conversely are performed. The measurement apparatus of communication source is an apparatus which transmits packet for simulated communication and the measurement apparatus of communication destination is an apparatus which receives packet for simulated communication.

The case where packet for simulated communication can be received between one measurement apparatus and the other measurement apparatus forming a pair for simulated communication mutually is the case where the simulated communication is successful and, for example, a point 0 that is the smallest estimation point is given.

The case where the packet for simulated communication transmitted from a measurement apparatus of the other party can be received by one own measurement apparatus but where the measurement apparatus of the other party cannot receive the packet for simulated communication transmitted from the own measurement apparatus is the case where the simulated communication fails. Accordingly, a point 1 is given as a next lower estimation point.

The case where the own measurement apparatus cannot receive the packet for simulated communication from the measurement apparatus of the other party but where the measurement apparatus of the other party can receive the packet for simulated communication from the own apparatus is also the case where the simulated communication fails. Accordingly, a point 2 is given as the next lower estimation point.

The case where both of the own apparatus and the measurement apparatus of the other party cannot receive the packet for simulated communication mutually is the case where the simulated communication fails completely and accordingly a point 3 is given as the highest estimation point. That is, the lower the quality of simulated communication is, the larger the estimation point is. The method of setting the points can be set freely and as the quality (success degree) of simulated communication is lowered, the estimation point may be made smaller. Other points except 0 to 3 may be given.

In FIG. 2, the fact that the measurement apparatuses do not receive the simulated communication packet from the measurement apparatuses of the other parties is memorized by setting the point of “2” in a pertinent space or column of the table. Blank columns in the table represent that the simulated communication packet can be received from the measurement apparatus of the other party.

Attention is paid to the first line of the table T10a. In the first line, points 2 are set the second and fifth times of the first set and the third time of the second set. The points mean that the measurement apparatus 630a (M1011) cannot receive the simulated communication packet from the measurement apparatus 630b (M1012) of the communication party and represent that reception of the simulated communication packet fails.

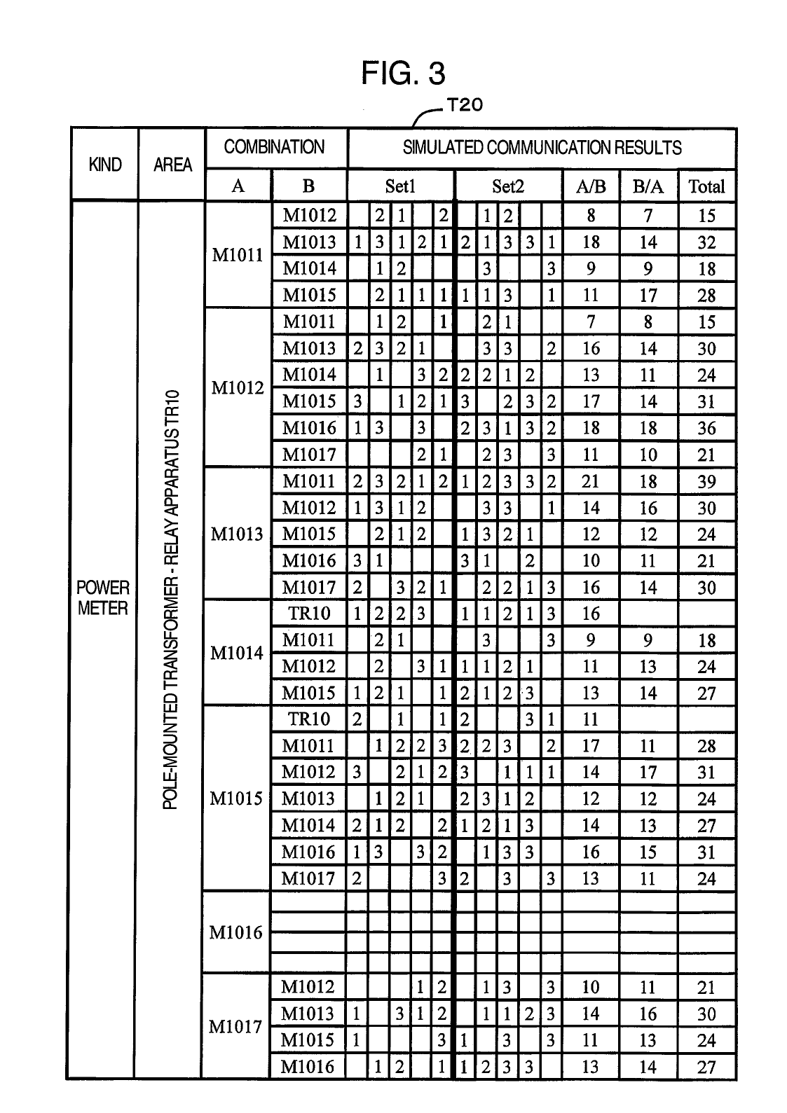

FIG. 3 is a table in which results of simulated communication among the measurement apparatuses are brought together or integrated. The integrated table T20 manages, for example, kind of measurement apparatuses, area, combination of measurement apparatuses and simulated communication results in a corresponding manner.

In an example of FIG. 3, the measurement apparatuses are power meters (measurement apparatuses 630) installed in the consumers 620. The area is sectioned by the pole-mounted transformer or the relay apparatus. Further, sectionalization may be made only by any one of the kind of measurement apparatuses and the area.

The combination shown at the upper part of the table T20 represents combination of measurement apparatuses forming pairs for simulated communication. In item A, the measurement apparatus on transmission side is described and in item B, the measurement apparatus on reception side is described. For example, when the measurement apparatus 630a (M1011) is an apparatus on transmission side A, the apparatuses on reception side B correspond to measurement apparatuses 630b (M1012), 630c (M1013), 630d (M1014) and 630e (M1015). Other measurement apparatuses shown on the transmission side A of the “combination” in the table T20 are also the same. For example, when the measurement apparatus 630d (M1014) is an apparatus on transmission side A, the apparatuses on reception side correspond to the relay apparatus 20 (TRIO) and the measurement apparatuses 630a (M1011), 630b (M1012) and 630e (M1015). Whether an apparatus can be paired with which apparatus is different in each measurement apparatus. This reason is that the apparatus residing within the communicable range becomes the other party of simulated communication.

“Simulated communication results” shown on upper right side of the integrated table T20 show points given to results of transmission and reception in simulated communication recorded and totalized by the measurement apparatuses. One column corresponds to one simulated communication. In the embodiment, one set is defined to be five times and simulated communication is made two sets in total.

The numerical values in columns of the simulated communication results represent the state of transmission and reception of simulated communication packet between the measurement apparatuses by points. Points memorized in the table T10 are recalculated in accordance with the combination of the measurement apparatuses as follows.

(1) When the columns in which simulated communication results corresponding between table T10 for the measurement apparatus of communication source and table T10 for the measurement apparatus of communication destination are represented are blank or point 0, corresponding columns between communication source and destination in the integrated table T20 are left to be blank or point 0. This case shows that transmission and reception of simulated communication packet between the measurement apparatuses of communication source and destination are successful.
(2) When “2” is recorded in one of corresponding columns indicating the simulation communication results in table T10 for the measurement apparatus of communication source and table T10 for the measurement apparatus of communication destination, “1” is memorized as a value of the other measurement apparatus in the integrated table T20. The case where the own apparatus cannot receive the simulated communication packet from the measurement apparatus of the communication party corresponds to the case where the measurement apparatus of the other party fails in transmission of the simulated communication packet conversely. This case shows that any one of the measurement apparatuses of communication source and destination fails in transmission or reception of simulated communication packet.
(3) When “2” is recorded in both of corresponding columns indicating the simulation communication results in both of table T10 for the measurement apparatus of communication source and table T10 for the measurement apparatus of communication destination, “3” is set in corresponding columns in communication source and destination in the integrated table T20. This case shows that both of the measurement apparatuses of communication source and destination fail in transmission and reception of simulated communication packet.

In column “A/B” of the integrated table T20, the total of points calculated in the above items (1) to (3) is memorized by being calculated in accordance with the following expression 1.

$${S}_{T}^{m} = {\sum }_{n} {S}_{n}^{m} \qquad [ Expression 1 ]$$

where S^{m}ₙ is point in each simulated communication, S^{m}_{T} the total of points, m a measurement apparatus ID and n the trial number of simulated communications.

“A/B” of the integrated table T20 shows the total of points in case where the measurement apparatus having ID described in column A is transmission side and the measurement apparatus having ID described in column B is reception side. To the contrary, “B/A” of the integrated table T20 shows the total of points in case where the measurement apparatus having ID described in column B is transmission side and the measurement apparatus having ID described in column A is reception side.

Description is made in case of combination of the measurement apparatuses 630a (M1011) and 630b (M1012), for example. “A/B” shows the total calculated in case where the measurement apparatus 630a (M1011) is transmission side (communication source) and the measurement apparatus 630b (M1012) is reception side (communication destination). In the same example, “B/A” shows the total calculated in case where the measurement apparatus 630b (M1012) is transmission side and the measurement apparatus 630a (M1011) is reception side. That is, values of “B/A” are equal to values in case where transmission side and reception side are exchanged in “A/B” corresponding thereto. In the plural measurement apparatuses forming pairs for simulated communications, values in both of “A/B” and “B/A” can be calculated to thereby estimate the reliability of communication routes between the measurement apparatuses in bidirectional direction.

At right end of the integrated table T20, the totals of values in columns “A/B” and “B/A” are shown. This total is an estimation value in bidirectional direction for a certain communication route. It can be considered that as the total is smaller, communication at the time of simulated communication is stable and the number of times of occurrences of trouble is smaller. Accordingly, in the embodiment, when plural measurement apparatuses reside in the communication range of a certain measurement apparatus, the measurement apparatus having the smallest final total in the integrated table T20 is selected as the measurement apparatus of communication party. This reason is that the communication path between the measurement apparatus to be judged and the measurement apparatus having the smallest final total is considered to be most stable.

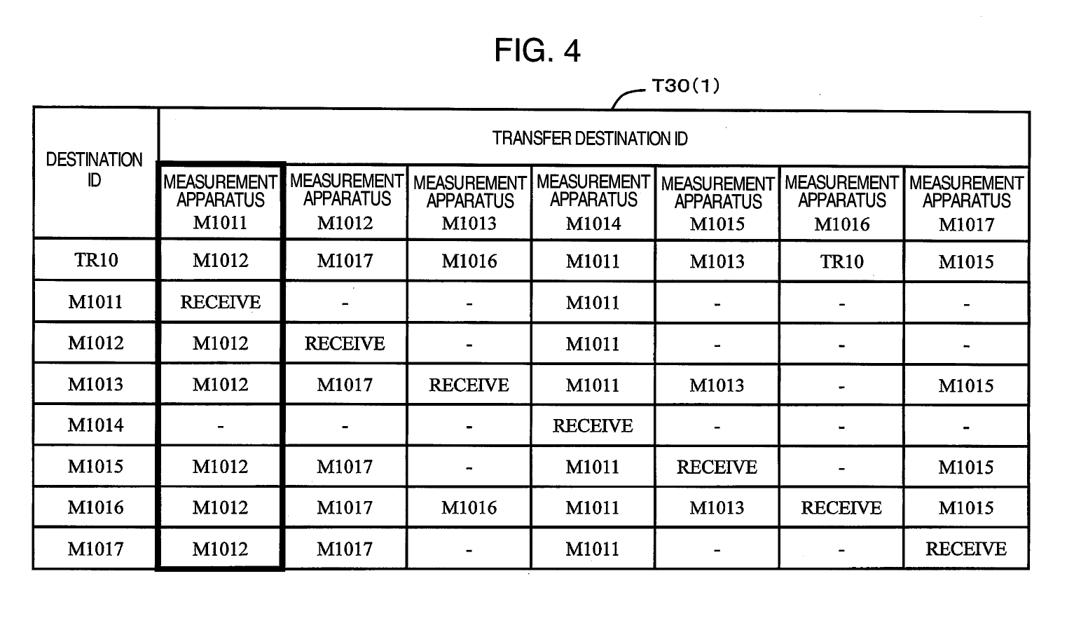

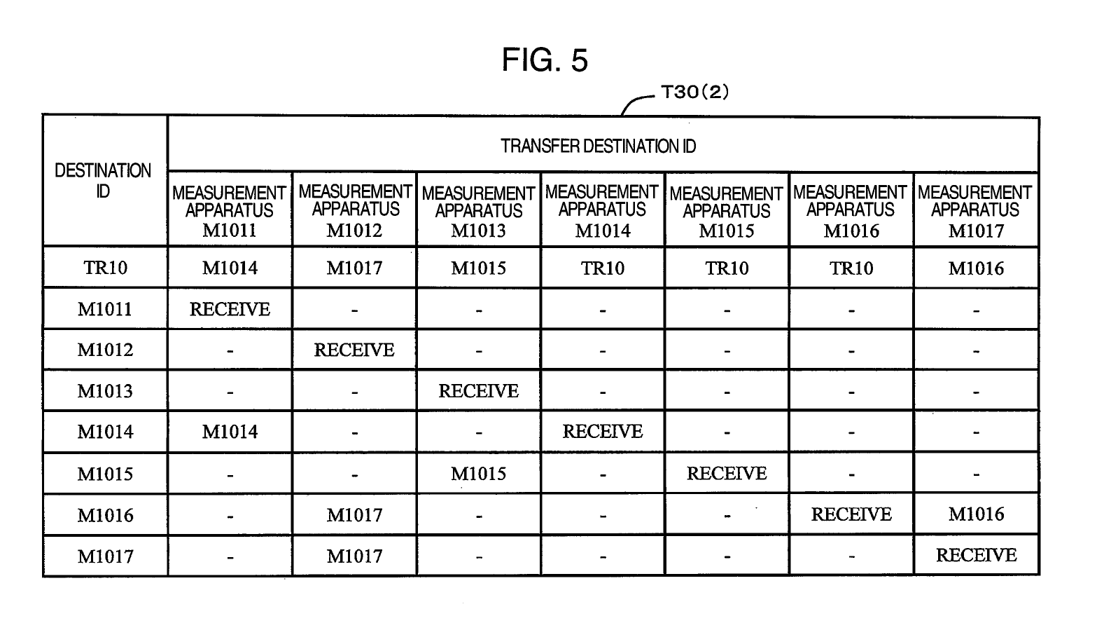

Referring now to FIGS. 4 and 5, communication route tables T30 are described. The communication route tables T30 are prepared on the basis of the integrated table T20 shown in FIG. 3.

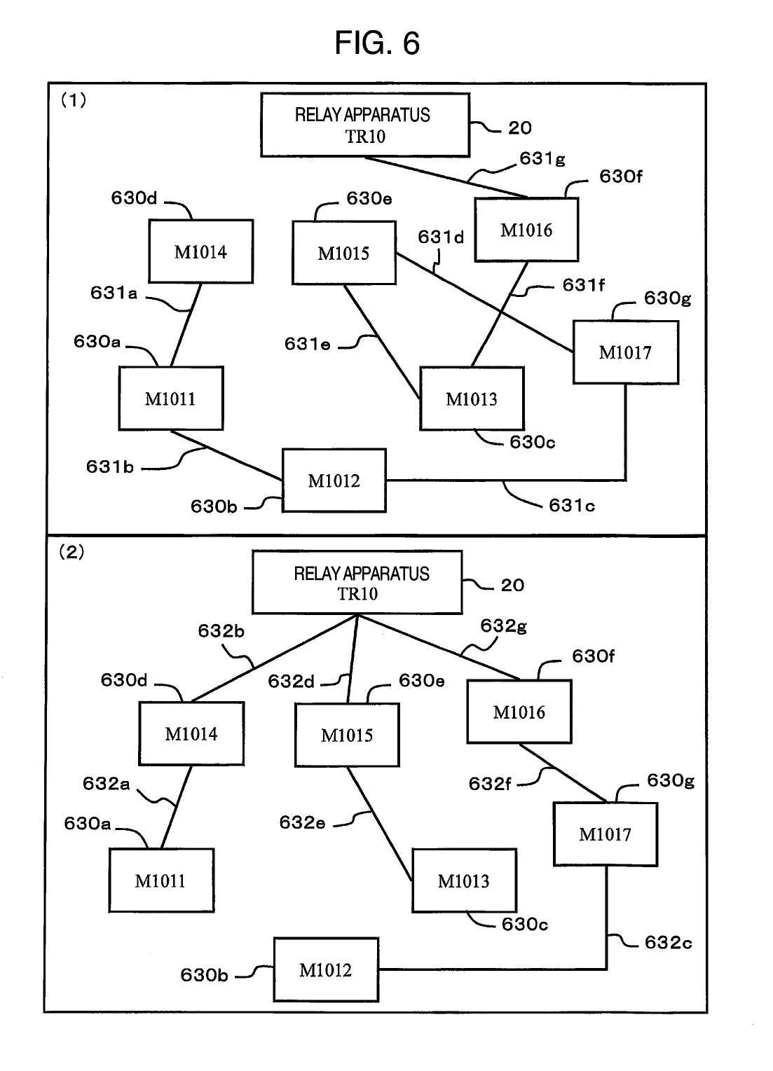

FIG. 4 is a diagram corresponding to the topology in the form of chain shown in FIG. 6 (1). FIG. 5 is a diagram corresponding to the topology in the form of chain having the relay apparatus shown in FIG. 6 (2) as a root. Unless otherwise specified, the communication route tables T30 (1) and T30 (2) are named communication route table T30.

The communication route table T30 stipulates routes in case where the packet in which measured data is stored is transmitted from the measurement apparatuses 630 to the relay apparatus 20. The communication direction directing from the measurement apparatus to the relay apparatus 20 is named the up direction (upstream direction), here. The communication direction directing from the relay apparatus 20 to the measurement apparatus is named the down direction (downstream direction).

The communication route table T30 manages, for example, destination ID's of information and transfer destination ID's of the information in a corresponding manner. The transfer destination ID is ID of an apparatus to which the information is transferred. In the communication route table T30, communication routes for the measurement apparatuses 630a to 630g are brought together or integrated as one table. The communication route notification part 140 of the communication route setting apparatus 10 notifies only information corresponding to the measurement apparatuses of the communication route table T30 to the measurement apparatuses.

As shown by thick black frame in FIG. 4, description is made by taking the measurement apparatus 630a (M1011) as an example. When the measurement apparatus 630a (M1011) receives packet having the relay apparatus 20 (TR10) as its destination, the measurement apparatus 630a (M1011) transfers the packet to the measurement apparatus 630b (M1012). When the measurement apparatus 630a (M1011) receives packet having its own apparatus (M1011) as its destination, the measurement apparatus 630a (M1011) receives the packet as it is and does not transfer it anywhere. When the measurement apparatus 630a (M1011) receives packet having the measurement apparatus 630b (M1012) as its destination, the measurement apparatus 630a (M1011) transfers the packet to the measurement apparatus 630b (M1012). When the measurement apparatus 630a (M1011) receives packet having the measurement apparatus 630c (M1013) as its destination, the measurement apparatus 630a (M1011) transfers the packet to the measurement apparatus 630b (M1012).

The measurement apparatus 630a (M1011) does not receive packet having the measurement apparatus 630d (M1014) as its destination. This reason is that, as shown in FIG. 6(1), the measurement apparatus 630d (M1014) is positioned downstream of the measurement apparatus 630a (M1011).

When the measurement apparatus 630a (M1011) receives packet having the measurement apparatus 630e (M1015), 630f (M1016) or 630g (M1017) as its destination, the measurement apparatus 630a (M1011) transfers the packet to the measurement apparatus 630b (M1012).

As described above, when the transfer destination ID of packet is ID (TR10, M1012, M1013, M1015, M1016 or M1017) of the measurement apparatus installed upstream of the measurement apparatus 630a (M1011), the measurement apparatus 630a (M1011) transfers the packet to the measurement apparatus 630b (M1012) next to the own apparatus 630a (M1011).

Since the measurement apparatus 630a (M1011) cannot receive the packet directed to the measurement apparatus 630d (M1014) positioned downstream of the measurement apparatus 630a (M1011), the measurement apparatus 630a (M1011) destroys the packet at the reception time of the packet. Similarly, even in other measurement apparatuses, packet is transmitted and received in accordance with the communication method shown in the communication route table T30 (1).

As described above, the destination ID and the transfer destination ID are set in each measurement apparatus, so that measurement value (packet) measured by the measurement apparatus can be transmitted along the predetermined communication route.

When the integrated table T20 of FIG. 3 is referred to, there are the measurement apparatuses 630b (M1012) and 630d (M1014) as candidates of the communication parties of the measurement apparatus 630a (M1011) according to the integrated table T20.

In combination of the measurement apparatuses 630a (M1011) and 630b (M1012), the final total is “15”. In combination of the measurement apparatuses 630a (M1011) and 630d (M1014), the final total is “18”. The totals in combination of the measurement apparatus 630a (M1011) and other measurement apparatuses 630c (M1013) and 630e (M1015) are “32” and “28”, respectively. Accordingly, candidates of communication party of the measurement apparatus 630a (M1011) are the measurement apparatuses 630b (M1012) and 630d (M1014) having the smaller final totals.

In the embodiment, the communication route setting apparatus 10 sets the communication route in view of configuration of communication parties of other measurement apparatuses based on the simulated communication results and/or the final totals totalized along the communication route. In the example described above, the communication route setting apparatus 10 sets the measurement apparatus 630b (M1012) as the transmission destination of the measurement apparatus 630a (M1011) and the measurement apparatus 630d (M1014) as the reception destination thereof.

As described later, when the communication route is set, the communication route setting apparatus 10 may use at least any one or more of trouble record information, the number of times of occurrences of communication trouble and accumulated values of past points read out from the route information database 320. For example, the order representing that the quality is stable may be set in ascending order of the number of times of occurrences of communication trouble. The measurement apparatus of communication party may be selected so that the measurement apparatus having higher order (the measurement apparatus having stable communication quality) is positioned upstream.

Alternatively, as described in the following expression 2, the measurement apparatus having the minimum total shown at right end of the integrated table T20 may be selected as a communication party and the communication route thereof may be set. In the expression 2, S_{R} represents the total of points in the whole communication routes and S^{m}_{T} represents the total of simulated communication results.

$${S}_{R} = min ( {\sum }_{m} {S}_{T}^{m} ) \qquad [ Expression 2 ]$$

FIG. 6 shows an example of topology of communication routes. FIG. 6(1) shows an example of communication routes of the type that beads are connected in a string and FIG. 6(2) shows an example of so-called tree-shaped communication routes.

The communication routes of the type that beads are connected in a string as shown in FIG. 6(1) are configured on the basis of the communication route table T30(1) of FIG. 4. In the configuration of the communication routes of FIG. 6(1), the relay apparatus 20 is the end or the final point and a communication route 631g, the measurement apparatus 630f, a communication route 631f, the measurement apparatus 630c, a communication route 631e, the measurement apparatus 630e, a communication route 631d, the measurement apparatus 630g, a communication route 631c, the measurement apparatus 630b, a communication route 631b, the measurement apparatus 630a, a communication route 631a and the measurement apparatus 630d are connected in a string.

The measurement apparatuses measure the system state periodically. Packet containing measured values of system information is transmitted to the relay apparatus 20 in the bucket-brigade method according to the communication routes shown in FIG. 6(1). The packet containing the measured values is hereinafter referred to as measured data for the purpose of understanding.

First, the measured data of the measurement apparatus 630d (M1014) is transmitted to the measurement apparatus 630a (M1011) through the communication route 631a. Next, the measured data of the measurement apparatus 630d and the measured data of the measurement apparatus 630a are transmitted from the measurement apparatus 630a (M1011) through the communication route 631b to the measurement apparatus 630b (M1012).

The measured data of the measurement apparatuses 630d, 630a and 630b is transmitted through the communication route 631c to the measurement apparatus 630g (M1017). Similarly, the measured data of the measurement apparatuses 630d, 630a, 630b and 630g is transmitted through the communication route 631d to the measurement apparatus 630e (M1015).

Similarly to the multihop communication, while the measured data of the measurement apparatuses is added, the measured data is transmitted to the relay apparatus 20 finally. The destination ID of the measured data of the measurement apparatuses is the relay apparatus 20 (TR10) and is set in the measurement apparatuses beforehand.

The tree-shaped communication routes shown in FIG. 6(2) are configured on the basis of the communication route table T30(2) of FIG. 5. In the communication route configuration shown in FIG. 6(2), three routes are extended from the relay apparatus 20.

One route is configured to connect a communication route 632b, the measurement apparatus 630d, a communication route 632a and the measurement apparatus 630a. Another route is configured to connect a communication route 632d, the measurement apparatus 630e, a communication route 632e and the measurement apparatus 630c. Still another route is configured to connect a communication route 632g, the measurement apparatus 630f, a communication route 632f, the measurement apparatus 630g, a communication route 632c and the measurement apparatus 630b.

For example, the measured data of the measurement apparatus 630a (M1011) is transmitted through the communication route 632a to the measurement apparatus 630d (M1014). The measurement apparatus 630d (M1014) adds the measured data of the own apparatus 630d (M1014) to the measured data of the measurement apparatus 630a and transmits the measured data of the measurement apparatuses 630a and 630d through the communication route 632b to the relay apparatus 20.

Similarly, the measured data of the measurement apparatus 630c (M1013) is transmitted through the communication route 632e to the measurement apparatus 630e (M1015). The measurement apparatus 630e (M1015) adds the measured data of the own apparatus 630e (M1015) to the measured data of the measurement apparatus 630c and transmits the measured data of the measurement apparatuses 630e and 630c through the communication route 632d to the relay apparatus 20.

Similarly, the measured data of the measurement apparatus 630b (M1012) is transmitted through the communication route 632c to the measurement apparatus 630g (M1017). The measured data of the measurement apparatuses 630b and 630g is transmitted through the communication route 632f to the measurement apparatus 630f. The measured data of the measurement apparatuses 630b, 630g and 630f is transmitted through the communication route 632g to the relay apparatus 20.

Operation of the embodiment is described. The simulated communication processing, the communication route decision processing and the like described below are realized by executing predetermined program by a CPU (Central Processing Unit) included in the relay apparatus 20 or the communication route setting apparatus 10. The predetermined program is stored in a memory accessible by the CPU. The predetermined program can be stored in the memory by remote operation from a program management server not shown. Instead of the configuration in which the CPU executes the computer program or together with the configuration, a hardware circuit such as IC (Integrated Circuit) and LSI (Large Scale Integration) may be used.

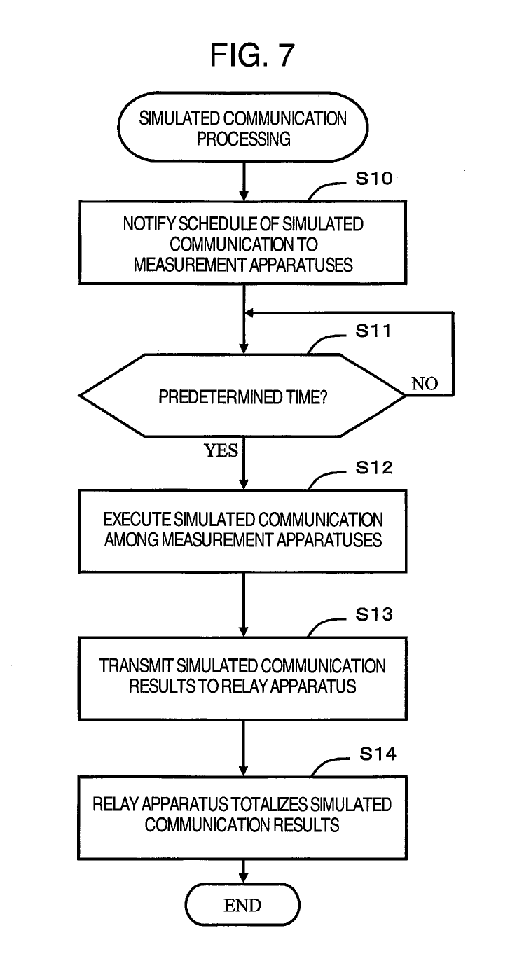

FIG. 7 is a flow chart showing the simulated communication processing. The simulated communication management part 210 of the relay apparatus 20 notifies a schedule of simulated communication to the measurement apparatuses 630 beforehand (S10). The schedule contains a schedule time for execution of simulated communication and ID of the measurement apparatus which is the other party of simulated communication. As described above, the simulated communication can be executed periodically or on occurrence of a predetermined event.

The measurement apparatuses 630 each include a timer and watch whether the predetermined time comes or not (S11). When the predetermined time comes (S11: Yes), the measurement apparatuses 630 execute the simulated communication among other measurement apparatuses installed around (other measurement apparatuses residing within the communicable range of the own measurement apparatus) (S12).

The measurement apparatuses 630 transmit results of the simulated communication (contents of the table T20 shown in FIG. 2) to the relay apparatus 20 (S13). The relay apparatus 20 totalizes the simulated communication results of the measurement apparatuses 630 and records them in the integrated table T20 (S14).

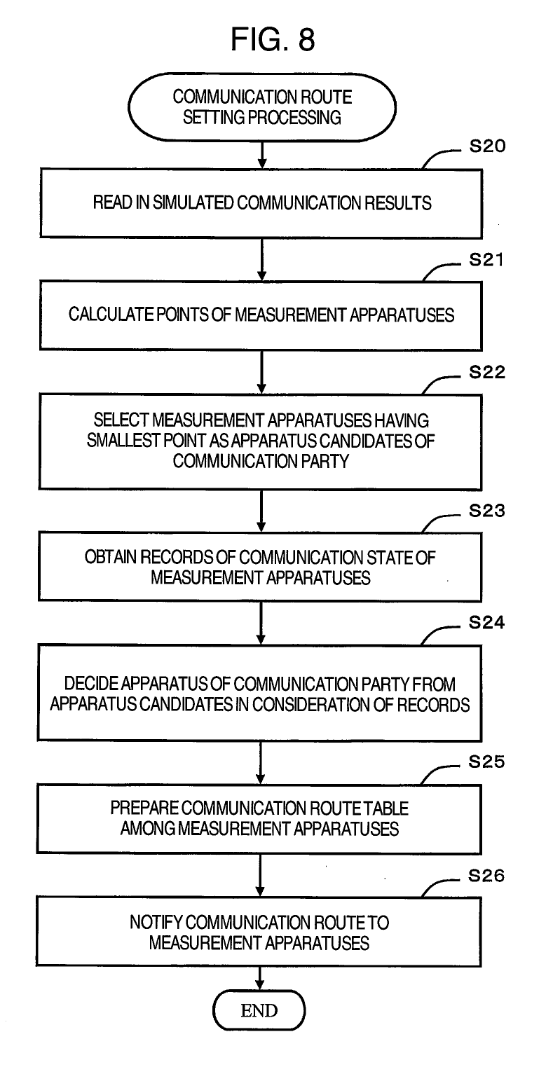

Referring now to the flow chart of FIG. 8, the simulated communication decision processing is described. In this processing, the communication routes connecting the measurement apparatuses 630 are decided on the basis of the stability for candidate routes (candidates of apparatuses of communication parties).

The statistical processing part 110 of the communication route setting apparatus 10 obtains simulated communication results from the simulated communication management part 210 of the relay apparatus 20 (S20). The statistical processing part 110 calculates points for estimating communication success frequencies among the measurement apparatuses on the basis of the simulated communication results (S21). The statistical processing part 110 collates points recorded in the measurement apparatuses on the basis of combinations of communication candidates among the measurement apparatuses.

At this time, the statistical processing part 110 collates points having the same trial numbers of simulated communications with one another. Since the measurement apparatus itself has point 2 recorded at the time that reception fails by itself, the statistical processing part 110 rewrites the points in accordance with the above-described items (1) to (3). The statistical processing part 110 calculates the total of points after collation in the measurement apparatuses (Expression 1).

The estimation part 120 of the communication route setting apparatus 10 selects at least one or more candidate apparatuses of communication party for each of the measurement apparatuses on the basis of the total calculated by the statistical processing part 110 (S22). The estimation part 120 selects plural (two) measurement apparatuses as communication party candidates in order of the small total, for example.

The estimation part 120 obtains records about the communication states of measurement apparatuses from the route information database 320 (S23). The record information of communication states can contain, for example, failure record information of measurement apparatuses, information indicating records of communication trouble such as the number of times of occurrences of communication trouble and accumulated values of past points.

When the plural communication party candidates selected in step S22 do not overlap other measurement apparatuses and a communication route can be decided uniquely, the estimation part 120 decides one communication party candidate decided uniquely as the measurement apparatus of communication party.

The communication party candidates selected can be also the communication party of other measurement apparatuses and accordingly when the communication route cannot be decided uniquely, the estimation part 120 ranks the communication party candidates in order on the basis of trouble records, the number of times of occurrences of communication trouble, accumulated values of past points and the like to be selected (S24).

Description is made by taking the accumulated values of past points as an example. In this case, it is judged that the higher the point of the measurement apparatus is, the larger the number of times of occurrences of communication trouble is and the measurement apparatus is installed downstream of the communication route. It is judged that the lower the point of the measurement apparatus is, the smaller the number of times of occurrences of communication trouble is and the measurement apparatus is installed upstream of the communication route (on the relay apparatus side).

In other words, when there are two measurement apparatuses as communication party candidates for the pertinent measurement apparatus, the estimation part 120 selects the measurement apparatus having the satisfactory communication state as the communication party installed upstream and the measurement apparatus having the bad communication state as the communication party installed downstream.

The communication route preparation part 130 prepares the communication route table (routing table) for each measurement apparatus on the basis of the communication party of each measurement apparatus decided in step S24 (S25). The communication route table contains an item of destination ID's concerning transmission and reception of information and an item of transfer destination ID's indicating the transfer destinations of information.

The communication route notification part 140 transmits the communication route table for each measurement apparatus prepared in step S25 to the corresponding measurement apparatus (S26) and this processing is ended.

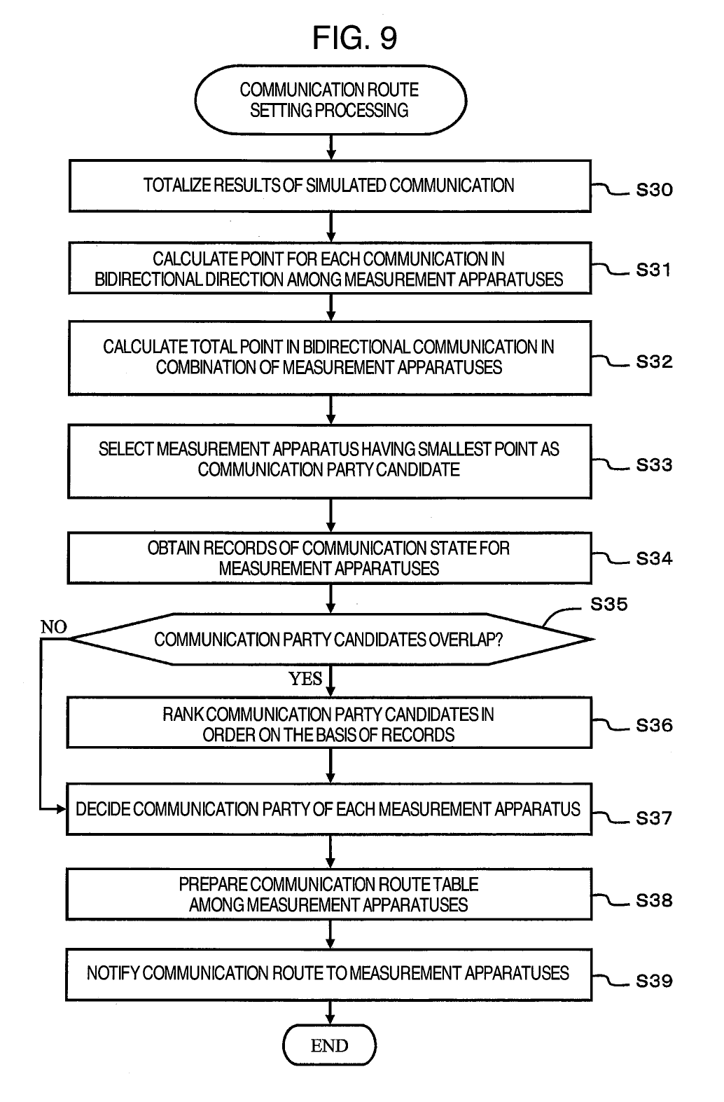

FIG. 9 is a flow chart showing another example of processing of deciding the communication route. The simulated communication management part 210 of the relay apparatus 20 totalizes the results of simulated communication (for each measurement apparatus) having the same trial numbers of simulated communications performed just before totalization among measurement apparatuses installed in the power distribution system (S30).

The statistical processing part 110 collates the simulated communication results of each measurement apparatus in accordance with combination of communication and calculates points in accordance with the procedures (1) to (3) described above (S31). The statistical processing part 110 calculates the total of points (S32). At this time, the statistical processing part 110 calculates the total (A/B) as viewed from the transmission side (A) and the total (B/A) as viewed from the reception side (B) as shown in the table T20 of FIG. 3 (expression 1). The statistical processing part 110 calculates the final total obtained by adding the totals (A/B) and (B/A).

The estimation part 120 compares the totals of points calculated in step S32 and selects one or more (two or more if possible) communication party candidates having the lower totals for each measurement apparatus. For example, in the table T20 of FIG. 3, the communication party candidates having the lower total for the measurement apparatus 630a (M1011) are two measurement apparatuses 630b (M1012) and 630d (M1014).

As described above, the final total of the measurement apparatus 630b (M1012) is “15” and the final total of the measurement apparatus 630d (M1014) is “18”. These final totals are smaller than the totals “32” and “28” of other measurement apparatuses 630c (M1013) and 630e (M1015), respectively. The estimation part 120 selects at least one or, plural if possible, measurement apparatuses as the communication party candidates in order of the smaller final total.

The estimation part 120 reads in records of the communication state for the measurement apparatus selected as the communication party candidate from the route information database 320 (S34). Here, attention is paid to the number of times of troubles among the records of the communication state.

The estimation part 120 gives points according to the number of times of troubles so that, for example, point 1 is given when the number of times of troubles is 1, point 2 is given when the number of times of troubles is 2 and point 3 is given when the number of times of troubles is 3. When the packet cannot be transmitted and received, it can be judged that trouble occurs.

The estimation part 120 judges whether the communication party candidates (or communication routes) selected in step S33 overlap each other for each of measurement apparatuses or not (S35). When the communication parties overlap (S35: Yes), the estimation part 120 ranks the communication party candidates in order on the basis of the number of times of troubles (S36).

The estimation part 120 decides the communication party of each measurement apparatus on the basis of the ranked results (S37). In the above example, the case where the final points of the measurement apparatuses 630b (M1012) and 630e (M1015) which are communication party candidates of the measurement apparatus 630a (M1011) are the same is considered.

For example, when the accumulated point of the measurement apparatus 630b (M1012) is smaller than the accumulated point of the measurement apparatus 630e (M1015), the measurement apparatus 630b (M1012) is selected as the communication party of the measurement apparatus 630a (M1011).

Further, when the tree-shaped topology is allowed, a certain measurement apparatus may be selected as the communication party of plural measurement apparatuses. When a sensor network (communication system) is configured by the tree-shaped topology, at least one communication party candidate may be extracted. In case of the topology of the type that beads are connected in a string, at least two communication party candidates may be extracted except the measurement apparatus at the end.

The communication route preparation part 130 prepares the communication route table (routing table) of each measurement apparatus on the basis of the decided communication party of each measurement apparatus (S38) and notifies it to each pertinent measurement apparatus (S39). Then, this processing is ended.

In the embodiment described above, the simulated communication is made among the measurement apparatuses beforehand and the communication routes for connecting measurement apparatuses are set in accordance with the simulated communication results. Accordingly, the more stable communication route can be set in accordance with the actual situation under circumstances where communication environment is varied every day, so that the reliability of the communication system for power distribution can be improved.

In the embodiment, since the simulated communication is performed plural times to make statistical processing, influence of temporary communication trouble can be excluded and the communication route can be set with high accuracy.

In the embodiment, when the communication party candidates overlap (for example, the points are the same as a result of statistical processing), the communication party apparatus is decided on the basis of the records of communication state. Accordingly, the more stable communication route can be set and the reliability of the communication system can be improved.

In the embodiment, the communication route is set so that the measurement apparatus having the stable communication state is positioned upstream of communication route. That is, the communication routes of the whole communication system are set so that the apparatus having smaller point after statistical processing or the apparatus having smaller point and the smaller number of times of occurrences of trouble is installed nearer the relay apparatus. Consequently, the possibility that the packet containing measured data is lost due to communication trouble can be reduced.

### Embodiment 2

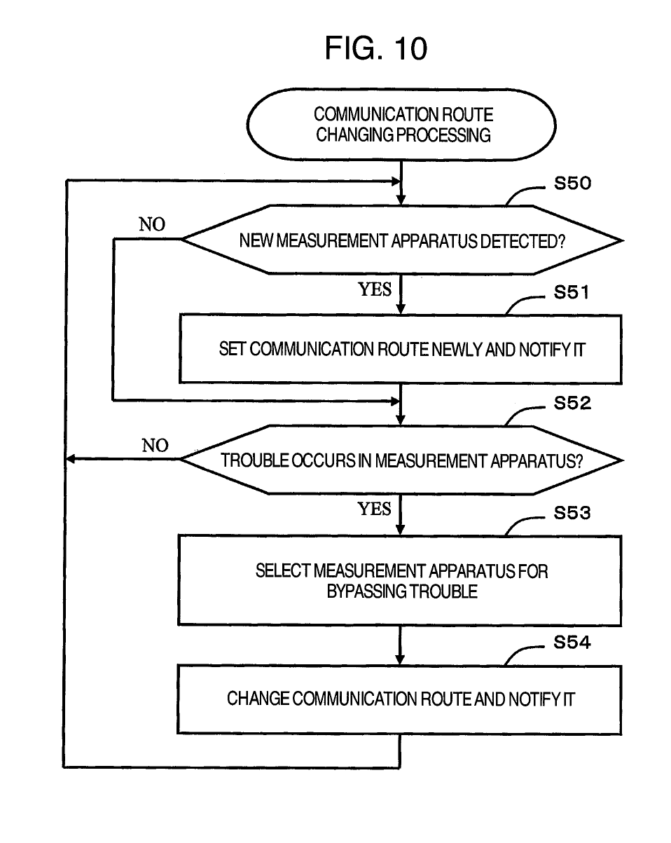

Referring now to FIG. 10, the second embodiment is described. The following embodiments including this embodiment are modification examples of the first embodiment. Accordingly, difference from the first embodiment is described mainly. In this embodiment, the communication route is changed in accordance with change in configuration of the communication system for power distribution.

FIG. 10 is a flow chart showing processing of changing the communication route. The communication route setting apparatus 10 judges whether a new measurement apparatus is added in the power distribution networks (high-voltage power distribution system 50 and low-voltage power distribution system 60) (S50).

For example, when a new measurement apparatus is installed in the power distribution network, the new measurement apparatus transmits predetermined packet around. When any of the existing measurement apparatuses receives the predetermined packet, the measurement apparatus transfers the packet through the relay apparatus 20 to the communication route setting apparatus 10.

When addition of the new measurement apparatus is detected (S50: Yes), the communication route setting apparatus 10 sets a communication route for the new measurement apparatus and notifies the communication route to the pertinent measurement apparatuses (S51). In the most simple method, the measurement apparatus which has received the predetermined packet from the new measurement apparatuses is selected as communication party candidates and any one of communication party candidates is selected as the measurement apparatus of communication party.

When addition of new measurement apparatus is not detected (S50: No), the communication route setting apparatus 10 judges whether trouble occurs in the existing measurement apparatuses or not (S52). Here, the trouble does not mean temporary trouble but means trouble occurring for a relatively long time such as stoppage of the measurement apparatus caused by any failure or removal of the measurement apparatus. For example, the trouble contains, for example, the case where the life of the measurement apparatus is ended, the measurement apparatus is destroyed due to fire and the measurement apparatus is demolished due to reconstruction of a building in which the measurement apparatus is installed.

When occurrence of trouble is detected (S52: Yes), the communication route setting apparatus 10 searches for a communication route for bypassing the measurement apparatus in which trouble occurs and selects the measurement apparatus which forms the communication route (S53). The communication route setting apparatus 10 notifies change of the communication route to the measurement apparatuses forming the newly prepared communication route for bypass (S54).

The embodiment configured above also attains the same effects as the first embodiment. Furthermore, the embodiment can cope with even the case where the measurement apparatus is added newly and the case where permanent trouble occurs in the measurement apparatus.

### Embodiment 3

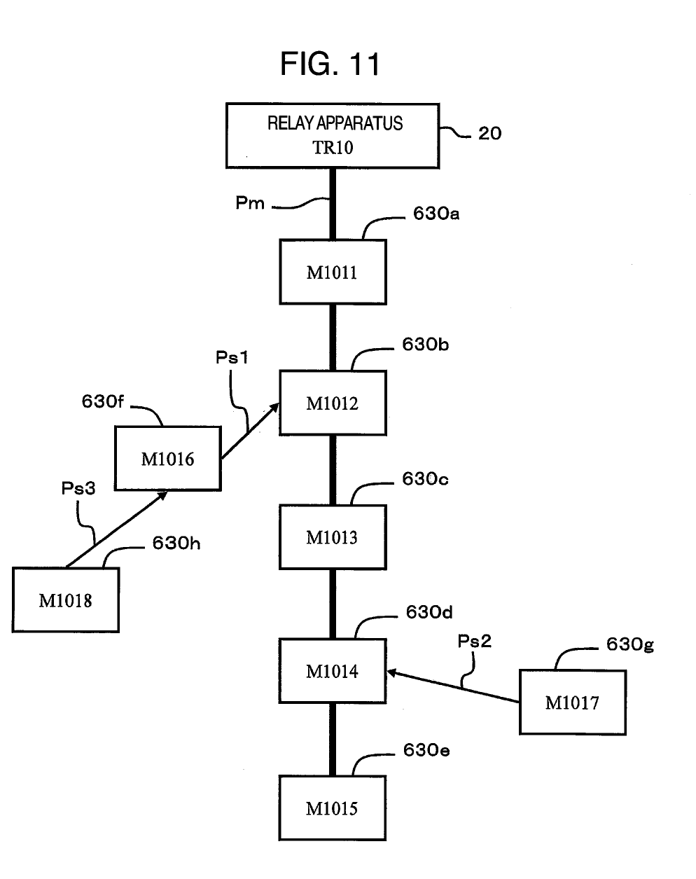

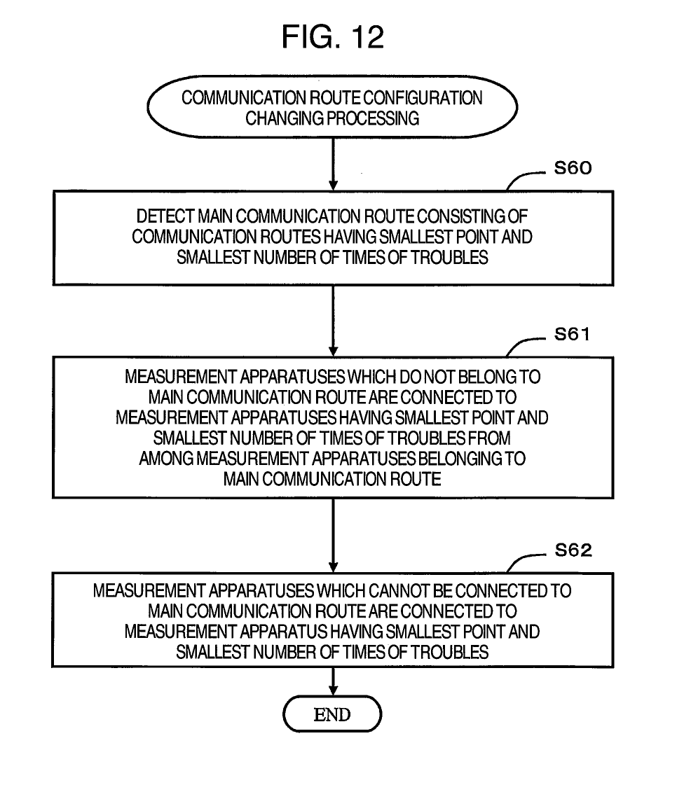

Referring now to FIGS. 11 and 12, the third embodiment is described. FIG. 11 illustrates a network configuration of the communication system according to the embodiment and FIG. 12 is a flow chart showing processing of changing a communication route.

In the embodiment, a route having the most stable communication state is detected from the communication system for power distribution and is set as a main communication route Pm (S60). For understanding of description, the measurement apparatuses 630a to 630e belonging to the main communication route Pm are named first measurement apparatuses. The communication route having the most stable communication state is the communication route having the smallest final total and the smallest number of times of troubles.

The measurement apparatuses 630f and 630g communicable with any of the first measurement apparatuses 630a to 630e from among the measurement apparatuses 630f, 630g and 630h which do not belong to the main communication route Pm are named second measurement apparatuses.

Communication routes Ps1 and Ps2 are set so that the second measurement apparatuses 630f and 630g are connected to the first nearest measurement apparatuses 630b and 630d, respectively (S61). In the example of FIG. 11, the communication route Ps1 for connecting the second measurement apparatus 630f to the first measurement apparatus 630b is set. Similarly, the communication route Ps2 for connecting the second measurement apparatus 630g to the first measurement apparatus 630d is set.

The measurement apparatus 630h which cannot directly communicate with any of the first measurement apparatuses 630a to 630e is named a third measurement apparatus. A communication route Ps3 is set so that the third measurement apparatus 630h is connected to the second measurement apparatus 630f installed around the third measurement apparatus 630h and communicable with the third measurement apparatus 630h (S62).

The embodiment configured above attains the same effects as the first embodiment. Furthermore, in the embodiment, the main communication route Pm having stable communication is detected and communication routes Ps1 to Ps3 for connecting other measurement apparatuses around the main communication route Pm are set. Accordingly, the relatively stable communication route can be set promptly in accordance with change of concrete communication environment.

The present invention is not limited to the above embodiments. Various additions and modifications can be made without departing from the spirit and scope of the present invention. For example, the communication route setting apparatus 10 and the power information management apparatus 30 may be configured by a single apparatus and part or all of function of the communication route setting apparatus 10 may be provided in the relay apparatus 20.

1. A communication system for power distribution for communicating with plural measurement apparatuses included in a power distribution network, wherein
the measurement apparatuses have function to communicate with other measurement apparatuses within a predetermined range by radio and
the communication system comprises:
a simulated communication result collection part to collect results of simulated communication performed among the measurement apparatuses and the other measurement apparatuses residing within the predetermined range and manage the results; and
a communication route setting part to set communication routes among the measurement apparatuses on basis of the results of the simulated communication obtained from the simulated communication result collection part,
the communication route setting part performing the following:
deciding a measurement apparatus of a communication party of each measurement apparatus for each of the measurement apparatuses on the basis of the results of the simulated communication at least one by one; and
notifying information about the measurement apparatus decided as the communication party to the measurement apparatuses and setting the communication routes.

2. A communication system for power distribution according to claim 1, wherein
the simulated communication is performed plural times among the measurement apparatuses, and
the communication route setting part performs the following:
statistically processing success or failure of the simulated communication;
estimating results of the statistical processing; and
deciding the measurement apparatus of the communication party from among the measurement apparatuses with which the measurement apparatuses can communicate for each of the measurement apparatuses on the basis of the estimation of the statistical processing at least one by one.

3. A communication system for power distribution according to claim 2, wherein
the communication route setting part performs the following:
obtaining records of communication trouble from a communication trouble information management part which manages information about communication trouble; and
deciding the measurement apparatus of the communication party from among the measurement apparatuses with which the measurement apparatuses can communicate for each of the measurement apparatuses on the basis of the results of the statistical processing and the records of the communication trouble at least one by one.

4. A communication system for power distribution according to claim 3, wherein
the communication route setting part performs the following:
statistically processing success or failure of the simulated communication so that points is made smaller as the number of successes of the simulated communication is increased; and
deciding a measurement apparatus having smallest points and the minimum number of times of occurrences of the communication trouble from among the measurement apparatuses with which the measurement apparatuses can communicate as the measurement apparatus of the communication party at least one by one for each of the measurement apparatuses.

5. A communication system for power distribution according to claim 4, wherein the communication route setting part sets the communication route so that measurement apparatuses in combination with each other are installed nearer the simulated communication result collection part in case where the measurement apparatuses in the combination have the smallest points and the minimum number of times of occurrences of the communication trouble.

6. A communication system for power distribution according to claim 5, wherein
the communication route setting part performs the following:
detecting a communication route containing the combination of first measurement apparatuses having the smallest points and the minimum number of times of occurrences of the communication trouble as a main communication route;
setting the communication route so that second measurement apparatuses which do not belong to the main communication route among the measurement apparatuses and can communicate with any of first measurement apparatuses are connected to any of the first measurement apparatuses communicable therewith; and
setting the communication route so that third measurement apparatuses which do not belong to the main communication route among the measurement apparatuses and cannot directly communicate with any of the first measurement apparatuses are connected to any of the second measurement apparatuses communicable therewith among the second measurement apparatuses.

7. A communication system for power distribution according to claim 6, wherein
the measurement apparatuses measure electricity containing at least one of voltage, current, electric power and frequency in installed places thereof and transmit information of the measured electricity to the measurement apparatuses of the communication parties.

8. A communication system for power distribution according to claim 7, wherein
the simulated communication result collection part is provided in a relay apparatus for relaying communication between the measurement apparatuses and the communication route setting part.

9. A communication system for power distribution according to claim 8, wherein
the communication trouble information management part is provided in a power information management apparatus which receives the electricity information from the measurement apparatuses through the relay apparatus and manages the electricity information.

10. A communication route setting apparatus for setting communication routes for communicating with plural measurement apparatuses included in a power distribution network, wherein
the measurement apparatuses have function to communicate with other measurement apparatuses within a predetermined range by radio and
the communication route setting apparatus performs the following:
obtaining results of simulated communication from a simulated communication result collection part which collects the results of simulated communication performed among the measurement apparatuses and the other measurement apparatuses residing within the predetermined range and manages the results;
deciding a measurement apparatus of a communication party of each measurement apparatus for each of the measurement apparatuses on the basis of the results of the simulated communication at least one by one; and
notifying information about the measurement apparatus decided as the communication party to the measurement apparatuses and setting the communication routes.

11. A method of setting communication routes for communicating with plural measurement apparatuses included in a power distribution network by a computer, wherein
the measurement apparatuses have function to communicate with other measurement apparatuses within a predetermined range by radio and
the computer performs the following:
obtaining results of simulated communication from a simulated communication result collection part which collects the results of simulated communication performed among the measurement apparatuses and the other measurement apparatuses residing within the predetermined range and manages the results;
deciding a measurement apparatus of a communication party of each measurement apparatus for each of the measurement apparatuses on the basis of the results of the simulated communication at least one by one; and
notifying information about the measurement apparatus decided as the communication party to the measurement apparatuses and setting the communication routes.
